(19) United States
(12) Patent Application Publication
(10) Pub. No.: US 2016/0124990 A1
(43) Pub. Date: May 5, 2016

(54) SYSTEM AND METHOD FOR DETERMINING OCCURRENCES OF DATA CORRUPTION IN A FILE SYSTEM UNDER ACTIVE USE

(71) Applicant: NetApp, Inc., Sunnyvale, CA (US)

(72) Inventors: Darrell Suggs, Sunnyvale, CA (US); James McKinion, Sunnyvale, CA (US)

(21) Appl. No.: 14/534,039

(22) Filed: Nov. 5, 2014

(51) Int. Cl. G06F 17/30

(52) U.S. Cl. CPC G06F 17/30221; G06F 17/30215; G06F 17/30132; G06F 17/30079

(57) ABSTRACT

A client system is provided for a test environment in which resources of a network file system are under test. A resource under test can correspond to an appliance (such as a cache or data migration appliance), or alternatively, to a file system. The client system can replicate operations specified for the file system on a control data set. The control data set can represent a copy of the file system that is handling the client specified file system operations during a test session. A comparison of the control data set to data stores which hold data for the resource under test can identify when temporary or permanent corruption issues occur.

### TECHNICAL FIELD

Examples described herein relate to a network-based file system, and more specifically to a system and method for determining occurrences of data corruption in a file system under active use.

### BACKGROUND

Network-based file systems include distributed file systems which use network protocols to regulate access to data. Network File System (NFS) protocol is one example of a protocol for regulating access to data stored with a network-based file system. The specification for the NFS protocol has had numerous iterations, with recent versions NFS version 3 (1995) (See e.g., RFC 1813) and version 4 (2000) (See e.g., RFC 3010). In general terms, the NFS protocol allows a user on a client terminal to access files over a network in a manner similar to how local files are accessed. The NFS protocol uses the Open Network Computing Remote Procedure Call (ONC RPC) to implement various file access operations over a network.

Other examples of remote file access protocols for use with network-based file systems include the Server Message Block (SMB), Apple Filing Protocol (AFP), and NetWare Core Protocol (NCP). Generally, such protocols support synchronous message-based communications amongst programmatic components.

### BRIEF DESCRIPTION OF THE DRAWINGS

FIG. 1A illustrates an example of a system for use in a data migration appliance test environment, according to an embodiment.

FIG. 1B illustrates an example of a system for use in a cache appliance test environment, according to an embodiment.

FIG. 1C illustrates an example of a system for use in a file system test environment, according to an embodiment.

FIG. 2 illustrates an example method for evaluating resources of a network file system in a test environment, according to an embodiment.

FIG. 3 is a block diagram that illustrates a computer system upon which embodiments described herein may be implemented.

### DETAILED DESCRIPTION

According to some embodiments, a client system is provided for a test environment in which resources of a network file system are under test. A resource under test can correspond to an appliance (such as a cache or data migration appliance), or alternatively, to a file system. The client system can replicate operations specified for the file system on a control data set. The control data set can represent a copy of the file system that is handling the client specified file system operations during a test session. A comparison of the control data set to data stores which hold data for the resource under test can identify when temporary or permanent corruption issues occur.

In some embodiments, a client system is established to utilize a test environment. The test environment can include a plurality of resources, including a file system that has file system objects. The test environment can provide for implementing one or more resources that are to be under test during a test session. A control data set can be created based on the file system objects. A test session can be initiated in which the client system issues a plurality of file system operations, of which some are mutable operations that specify one or more corresponding file system objects in the file system. The file system operations can be issued to create, modify or delete file system objects that are stored with one or more data stores associated with the resource under test. The file system objects that are stored within the one or more data stores can include data that has corresponding items within the control data set. While the client system issues the plurality of file system operations, the plurality of file system operations can be replicated on the control data set. A determination can then be made as to whether a discrepancy exists as between individual file system objects that are stored within the one or more data stores and the corresponding data of the control data set.

According to an embodiment, a client system is established for using a file system that is fronted by an appliance. The client system implements operations to generate an active load on the file system, while at the same time detecting instances of data corruption which can be caused as a result of the presence and/or operation of the appliance. In particular, examples described herein enable detection of temporal data corruption which can result in error or corruption being propagated to other client computers, while the corruption on the file system can subsequently be overwritten.

According to examples described herein, an intermediate and in-line appliance is provided to intercept and forward communications directed for a file system by one or more clients. The appliance can be said to front the file system by being positioned logically in front of the file system to intercept and handle requests issued from the client system.

In an embodiment, a client system is established to access and utilize a file system that is fronted by an appliance. A control data set is created based on the file system objects contained within the file system. A session is initiated in which the client system issues file system operations on the file system. The file system operations can include mutable and non-mutable operations which specify an object of the file system. While the client system issues the file system operations, the file system operations can also be replicated on the control data set. A determination can be made as to whether a discrepancy exists between individual objects of the file system and corresponding objects of the control data set.

In some variations, a session is implemented in the form of a migration. As a migration appliance, the appliance operates to create, modify or delete a set of file system objects that are based on the file system and which are specified by the individual file system operations issued from the client system. Still further, in some variations, the session is implemented for a caching appliance.

As used herein, the terms “programmatic”, “programmatically” or variations thereof mean through execution of code, programming or other logic. A programmatic action may be performed with software, firmware or hardware, and generally without user-intervention, albeit not necessarily automatically, as the action may be manually triggered.

One or more embodiments described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component can exist in a hardware component independently of other modules/components or a module/component can be a shared element or process of other modules/components, programs or machines. A module or component may reside on one machine, such as on a client or on a server, or may alternatively be distributed among multiple machines, such as on multiple clients or server machines. Any system described may be implemented in whole or in part on a server, or as part of a network service. Alternatively, a system such as described herein may be implemented on a local computer or terminal, in whole or in part. In either case, implementation of a system may use memory, processors and network resources (including data ports and signal lines (optical, electrical etc.)), unless stated otherwise.

Furthermore, one or more embodiments described herein may be implemented through the use of instructions that are executable by one or more processors. These instructions may be carried on a non-transitory computer-readable medium. Machines shown in figures below provide examples of processing resources and non-transitory computer-readable mediums on which instructions for implementing one or more embodiments can be executed and/or carried. For example, a machine shown for one or more embodiments includes processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and tablets) and magnetic memory. Computers, terminals, and network-enabled devices (e.g. portable devices such as cell phones) are all examples of machines and devices that use processors, memory, and instructions stored on computer-readable mediums.

System Overview

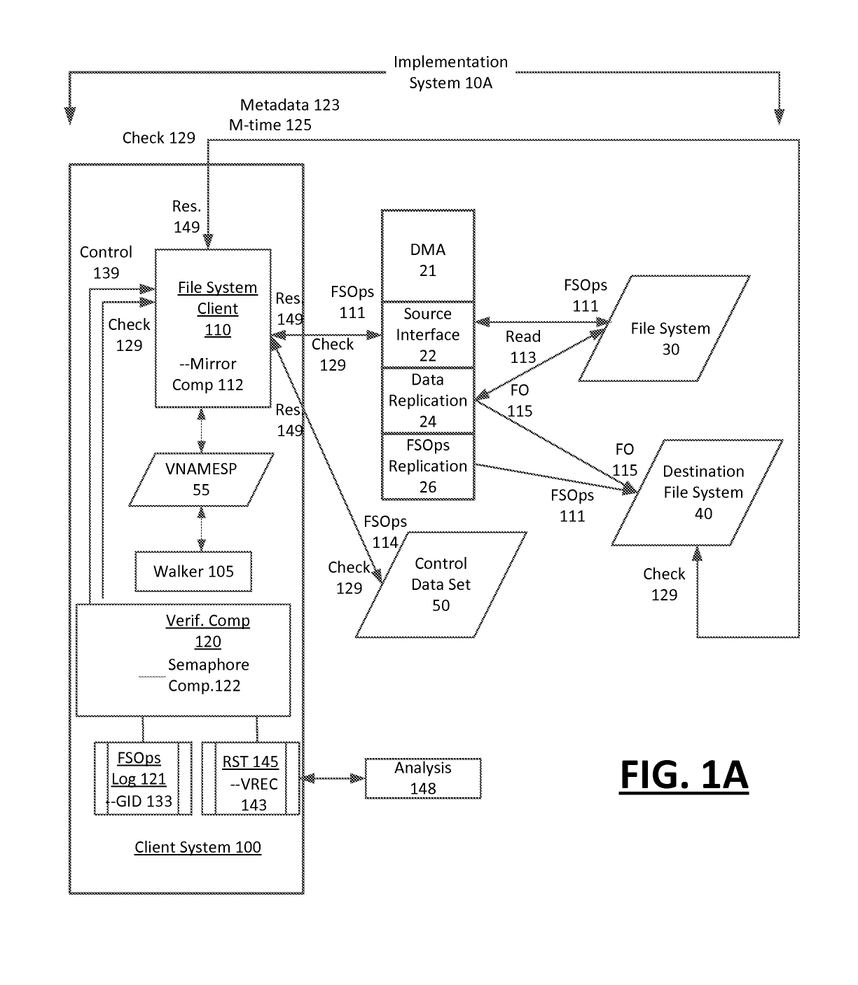

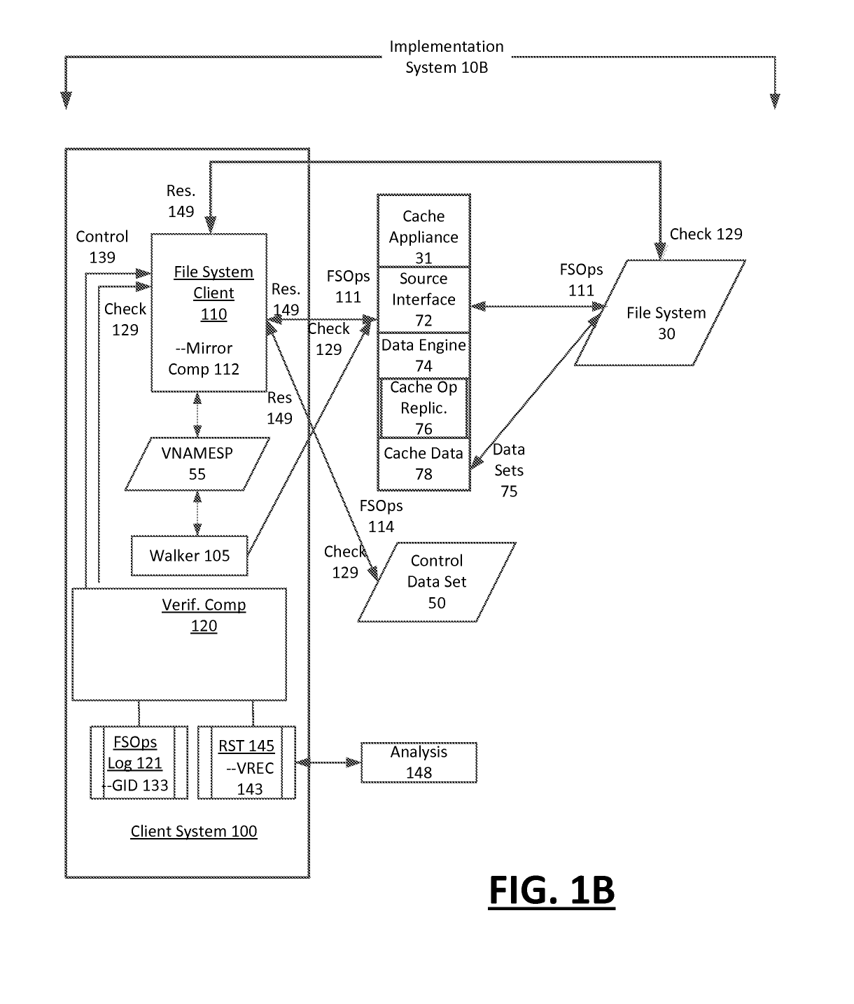

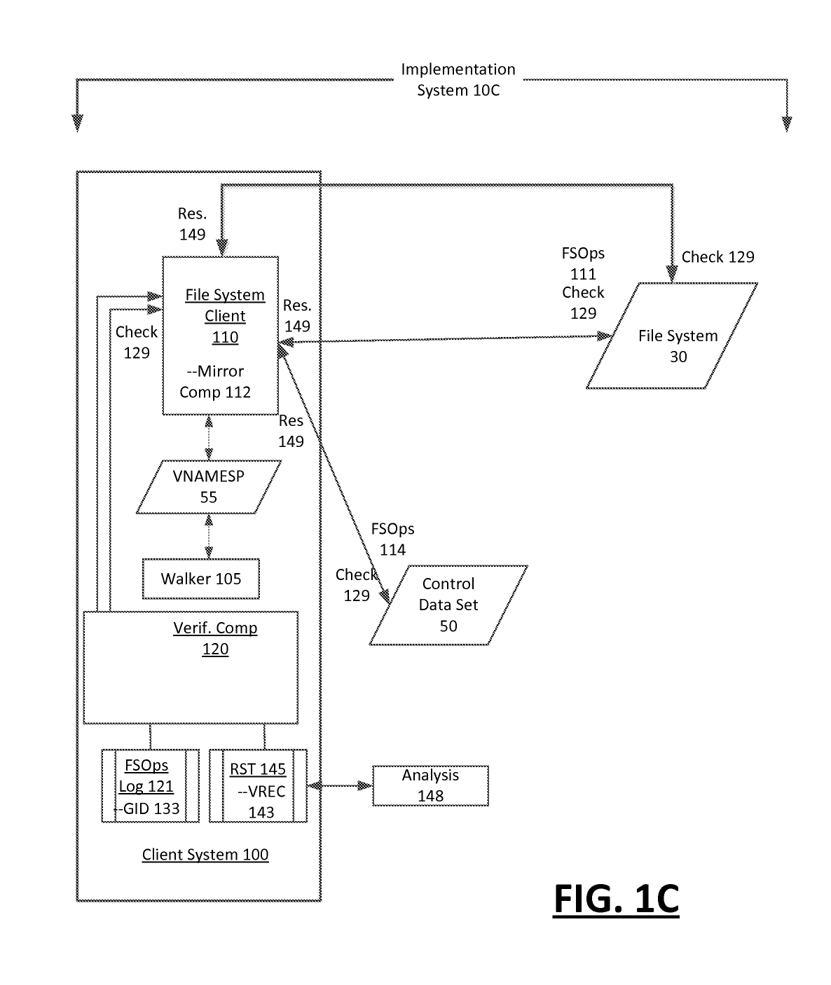

FIG. 1A through FIG. 1C illustrate different examples of a system for use in a test environment for evaluating resources of a network file system, according to an embodiment. More specifically, a system of each of FIG. 1A through FIG. 1C can operate to verify the operations of one or more resources in the test environment which, for example, create, modify, or delete file system objects on a resource of the test environment in response to client specified file system operations.

In examples shown, the client system 100 operates as part of an implementation system which includes a file system (“filer”) 30 having a file system data set. The implementation system 10A, 10B, or 10C can, for example, be provided as part of a test environment in which the client system 100 generates file system operations for the purpose of testing and evaluation. By way of example, the client system 100 can generate a load test on the file system 30 in one of multiple possible contexts, including a data migration implementation (FIG. 1A), a cache appliance implementation (FIG. 1B) or a file system implementation (FIG. 1C).

In implementations of FIG. 1A and FIG. 1B, the test environment is implemented to test the operation of an appliance that fronts the network file system. In particular, a corresponding implementation system 10A, 10B provides an operating environment in which the appliance is put under test (e.g., load performance). In an example of FIG. 1A, the appliance corresponds to a data migration appliance 21, and the test environment operates to validate the appliance 21 based on the file system objects that are maintained with a file system 30 during the migration, and migrated to a destination file system 40. These file system objects can reside, for example, within the file system 30 and/or the destination file system 40.

In an example of FIG. 1B, the appliance corresponds to a cache appliance 31, and the test environment operates to validate the appliance based on the file system objects that are created, altered or deleted by the client via the cache appliance 31. These file system objects can reside on, for example, the cache appliance 31, and/or within file system 30.

In an example of FIG. 1C, the test environment is used to test a file system, without use of an appliance. In such embodiments, the test environment operates to validate the file system objects that are maintained within the file system 30 during a test session.

Client Load Generation

With respect to examples of FIG. 1A through FIG. 1C, a client load is generated on a client system for the purpose of exercising a file system. According to some embodiments, a control data set 50 is used to mirror the implementation of client-issued operations for the file system 30. The client system 100 may be mounted to the filer 30 to actively issue file system operations for the filer. As described below, one example provides for the control data set 50 to be used to validate the integrity of the file system resource being tested (e.g., filer 30, destination filer 40, cached data set 75, etc.).

According to one implementation, the control data set 50 can be generated pre-run time as a copy of the data maintained with the filer 30. For example, a static copy or mirror operation can be used to generate the control data set 50. Both the filer 30 and the control data set 50 can include structure and data that is specific to a particular host system (e.g., a replication of a source file system that is actually in use by a host utilizing the implementation system), rather than being generic test data.

The client system 100 includes a file system client 110 and a verification component 120. The file system client 110 operates to generate a load on the filer 30, by issuing select file system operations 111 on the filer 30. The select file system operations 111 can include mutable operations, which are those operations which change the content or metadata of a specified file system object. In implementation, the select file system operations 111 can include mutable operations other than those operations which only alter change time (“ctime”) or access time (“atime”). In one implementation, the file system client 110 intelligently generates a client load on the filer 30 while the data migration appliance 21 performs the migration. In order to intelligently generate the load, the file system client 110 can use information about the structure and organization of the filer 30. The information about the structure and organization of the filer 30 can be determined from inspecting the source file system prior to initiating a session of a test environment.

According to one implementation, the file system client 110 accesses a virtual namespace 55 for the filer 30 in order to determine file system operations for the source filer when the session is initiated. In one embodiment, the client system 100 can include a walker 105 which issues operations to scan and discover information about the contents of the filer 30. In one implementation, the walker 105 implements a depth-first, recursive priority scheme in order to discover information about the contents the filer 30. An example implementation of walker 105 is described in U.S. patent application Ser. No. 14/290,854, which is hereby incorporated by reference in its entirety for all purposes. The walker 105 can perform its discovery of the filer 30 by issuing operations on the filer 30 directly or through a fronting appliance.

The file system client 110 can access the virtual namespace 55 determined for the filer 30 in order to select or otherwise determine the type and construction of the file system operations 111 that are issued onto the filer 30. In one implementation, for example, the file system client 110 implements random selection in determining the type of file system operations that are to be performed on the file system data set. In a variation, the file system client 110 can use a priority scheme to select file system operations based on, for example, a sampling of file system operations performed on a corresponding active file system data set. Among other information, the virtual namespace 55 also identifies the inodes and the objects of the data sets, along with the file paths of the various identified objects.

The file system client 110 of the client system 100 issues file system operations 111 onto the filer 30. In one embodiment, the file system client 110 includes a mirror component 112 that issues mirrored file system operations 114 to the control data set 50. The mirrored file system operations 114 can be issued for the control data set 50 at substantially the same time (e.g., simultaneously) as the file system operations 111 issued from the file system client 110.

In one session, the client system 100 generates file system operations 111 to access file system data from the file system 30. In examples of FIG. 1A and FIG. 1B, the appliances 21, 31 operate to intercept client-specified file system operations and file system responses. The respective data migration or cache appliance 21, 31 can operate to intercept and then implement the file system operations 111 directed to the filer 30, while the mirrored file system operations 114 issued for the control data set 50 are implemented without involvement from that appliance.

Data Migration Appliance

With further reference to examples of FIG. 1A, in one implementation system 10A, system 100 operates to verify the operation of the data migration appliance 21, which fronts the file system 30. The client system 100 operates to generate loads on the data migration appliance 21 in order to detect corruption errors in the data sets of the file system 30 through use of the appliance 21. While the comparisons can be performed when the migration is over or otherwise when the filer 30 is static, embodiments recognize that such comparisons can also be performed on a dynamic basis while the session is ongoing (e.g., while the migration is being performed). Thus the comparisons that are performed can be at a time when the migration of the implementation system 10A is active. The corruption errors that can be detected include both temporary and permanent corruption of file system objects. In particular, temporary corruptions under conventional approaches go substantially undetected despite such errors being able to propagate to other locations. For example, in the case of migration, a write operation that is handled by the data migration system could potentially result in the file system object or its metadata having incorrect data. Consequently, a subsequent read operation from the client system 100 for that file system object can return incorrect data. Additionally, when data migration is being performed, the corrupted file system object can be migrated to the destination filer 40. But another write operation from the client system 100 to the same file system object can eliminate the corruption on the filer 30. Under conventional approaches, the temporary corruption to the requested file system object is not detected, and as a consequence, the data read from the read operation is also invalid and undetected. In contrast, under an example of FIG. 1, the temporary corruption of a file system object or its metadata can be detected during the migration, in near real-time. By detecting if and when such corruption occurs, the implementation system 10A can validate the performance of the appliance 21.

In an example of FIG. 1A, data migration appliance 21 can include cache resources and other components to enable the migration of file system data from the filer 30 to the destination filer 40. In one implementation, the data migration appliance 21 is positioned in-line between the client system 100 and the filer 30, so as to (i) receive and forward file system operations 111 specified for the filer 30, (ii) replicate file system objects of the filer 30 to the destination filer 40, and (iii) replicate file system operations specified by the client system 100 for the filer 30 on the destination filer 40. An example of a data migration appliance 21 is provided with U.S. patent application Ser. Nos. 14/011,696, 14/011,699, 14/011,718, 14/011,719 and 14/011,723; all of which are hereby incorporated by reference in their respective entirety.

The data migration appliance 21 includes a source interface 22, a data replication engine 24, and a file system operation component 26. The source interface 22 can intercept the file system operations 111 issued by the client system 100 and intended for the filer 30. The source interface 22 can forward intercepted file system operations onto the filer 30. The source interface 22 can also selectively queue file system operations 111 that are specified from the file system client 110 for asynchronous performance on the destination filer 40. Specifically, the source interface 22 can queue or otherwise trigger performance, on the destination filer 40, of file system operations that are specified for the filer 30 and mutable to the contents or metadata of the file system objects. The source interface 22 can include cache for performing queueing operations to replicate file system operations on data objects being migrated to the destination filer 40. In this way, the data migration appliance 21 can migrate the filer 30 to the destination filer 40 while the client system 100 continues to access and specify file system operations for the filer 30.

The file system operation component 26 of the data migration appliance 21 can access the queue of the source interface 22 in order to replicate selective file system operations 111 on the destination filer 40, so that changes to the filer 30 are reflected in the destination filer 40. Thus, the file system operation component 26 can replicate mutable operations specified for the file system objects at the filer 30 onto the destination filer 40.

The data replication engine 24 operates to replicate file system objects 115 that are not in use on the destination filer 40. For example, the data replication engine 24 can operate to replicate file system objects at the destination filer 40 for file system objects that occupy a portion of the filer 30 that is not in use by the client system 100. The data replication engine 24 can issue read operations 113 for the filer 30 in order to obtain file system data 115, from which file system objects can be written to the destination filer 40.

In an implementation in which data migration appliance 21 is being tested, the verification component 120 can operate to validate that file system objects present on the filers 30, 40 are not corrupted by inherent performance of the migration operations. With data migration, corruption can, for example, occur (i) at the filer 30 and result in the client system 100 receiving corrupted data when performing, for example, a read-type operation, (ii) at the filer 30, after which the corrupted file system object is migrated to the destination filer 40, and/or (iii) at the destination filer 40 during the migration process. Examples recognize that the use of data migration appliance 21 (e.g., cache appliance, data migration system, etc.), which is positioned inline to intercept and forward communications as between the client system 100 and the filer 30, can inherently induce corruption to metadata or data of a file system object. Furthermore, under conventional approaches, such data corruption incidents can be unnoticed and even temporary, particularly when the file system is under active use. While temporary corruption can go undetected, the effects of the data corruption can cause a more global integrity issue. For example, a corrupted file system object can be read by a client of the file system, or in the context of migration, a corrupted file system object can be migrated to the destination filer 40. In contrast, in an example of FIG. 1A, even temporary corruption of file system objects (including their metadata) can be detected in near real-time. Among other benefits, such detection enables identification of (i) specific file system objects which are or were corrupted at one point in time, (ii) specific instances in time when the corruption occurred, (iii) specific file system operations which yielded corruption of a file system object.

Accordingly, the verification component 120 operates to detect in near real-time when file system objects of the data stores being validated are corrupted. Given that (i) the control data set 50 is identically the same (except for atime, mtime, and ctime) as the filer 30 at the start, and (ii) mutable file system operations 111 performed on the file system 30 are mirrored on the control data set 50, the various data sets of the implementation system should be the same. More specifically, the data migration appliance 21, the filer 30, the quiesced objects (as described below) on the destination filer 40, and the control data set 50 should be the same at any given moment during the session (e.g., migration). The verification component 120 can make the comparisons in order to determine the discrepancies amongst the data sets of the data migration implementation system.

The verification component 120 of client system 100 can determine when file system objects of the destination filer 40 are quiesced before performing comparison operations against the control data set 50. The verification component 120 receives metadata from the filer 30 and destination filer 40. The verification component 120 can compare a metadata-based parameter of the file system object at each of the source and destination filers 30, 40 in order to determine whether the metadata of the file system object at the source and destination filers match. If the metadata parameter matches, the verification component 120 can deem the file system object of the destination filer 40 quiesced, meaning that the file system object can be validated. Otherwise, the determination resulting from comparison of the metadata parameter is that the file system object has a different state between the source and destination filers 30, 40, indicating, for example, that the file system object is still in flux at the filer 30 and/or not quiesced at the destination filer 40. Prior to performing the comparison for a given file system object of the destination, the verification component 120 determines whether the file system object is quiesced. More specifically, if mutable operations are specified from client system 100 and directed to the filer 30, the mutable operations can be replicated at the destination filer 40. Accordingly, an example of FIG. 1A recognizes that file system objects should be quiesced at the destination 40 when migration is being performed, in order for the true state of the file system objects on the destination filer 40 to be known. If the file system object is not quiesced at the destination filer 40, the file system object may still be in flux at the source or destination, in which case the comparison of that file system object with the corresponding object of the control data set 50 would yield a false positive (change occurred result).

Accordingly, client system 100 retrieves metadata from the file system objects in order to track and verify the completion of file system operations during the migration of the filer 30 to the destination filer 40. The retrieved metadata is used to determine when the individual file system objects are quiesced. Once the file system object is determined to be quiesced at the destination filer, individual file system objects at the filer 30 can be compared to counterparts at the destination filer 40 to determine whether the mutable operation performed on the particular file system object was successfully reflected on the file system object at the destination filer 40. This determination can be made while the filer 30 is in active use with the client system 100.

According to one aspect, the metadata 123 can include time based metadata, specifically modification time (mtime 125), as well as other metadata for determining and implementing a semaphore (e.g., metadata parameter). The mtime 125 can identify when a given file system object is modified. More specifically, a mutable operation to a file system object at the filer 30 may automatically cause an mtime 125 update of the file system object at the filer 30. While mtime 125 can in some cases provide a mechanism for checking whether a mutable operation to a file system object at the filer 30 is migrated to the destination filer 40, examples recognize that mtime 125 in and of itself is unreliable in many of the cases where modification is made to a file system object at the filer 30. For example, not all mutable operations performed on the file system object at the filer 30 results in a mtime update. Rather, a file system operation that writes to the metadata of the file system object, but not its content, is mutable and does not alter mtime 125. Thus, in such scenarios, mtime 125 is not adequate for determining whether the mutable operation that was specified of the file system object at the filer 30, was accurately implemented for the file system object at the destination filer 40.

Additionally, when mutable operations are in the process of being performed, but not completed, an inconsistency can arise in the mtime 125 of the file system object between the source and destination filers. Specifically, the mtime 125 typically updates upon completion of a particular file system operation. As a result, the verification component 120 cannot rely entirely on mtime 125 to determine whether the migration is taken place because there still may be one or more pending operations on the particular file system object. In other words, the verification component 120 cannot determine whether the file system object is quiesced at the destination filer 40 as a result of operations being pending at the filer 30 when the mtime 125 is checked.

In one implementation, the verification component 120 includes a semaphore component 122. The semaphore component 122 can operate to update a metadata item of an individual file system object after completion of one or more mutable operations on that file system object. The verification component 120 can read the same metadata item from the file system object at the destination filer 40 in order to determine if the file system object is quiesced at the destination, and that no further pending mutable operations are in progress at the filer 30.

In order to update a given metadata item of individual file system objects, and further use the metadata item for validation, the client system retrieves and modifies select metadata from file system objects at the source filer 30. In particular, aspects described herein provide for the client system 100 to access and write or update a unique or non-repetitive item of the metadata 123 in order to facilitate validation by the verification component 120.

In one implementation, the client system 100 receives metadata 123 directly from each of the filer 30 and destination filer 40. For example, the client system 100 can be mounted to each of the filers 30, 40, in order to receive metadata 123 from the respective filer directly. Alternatively, the client system 100 can communicate with an intermediate component or system, such as data migration appliance 21, in order to receive the metadata 123. By way of example, the file system client 110 can issue file system operations that are received by the data migration appliance 21, and which query for metadata of specific file system objects residing on the source and destination filers. As described in greater detail, the verification component 120 uses the metadata 123 in order to verify that the file system objects that are being checked on the destination filer 40 against the control data set 50 are quiesced. In one implementation, once the file system objects are quiesced, the state of individual file system objects at the destination filer 40 can be validated as to whether the file system objects reflect performance of specified (or in-flight) mutable operations for the file system object at the filer 30. Once validated, the file system objects of the destination filer 40 can be compared against the control data set 50 to confirm the integrity of the file system object at the destination.

In one implementation, client system 100 accesses a group identifier (“GID”) 113 of individual file system objects residing with the filer 30. When the file system client 110 completes an operation, or alternatively, a set of operations, the semaphore component 122 operates to modify the GID 133. The modification to the GID 133 is then recorded in the virtual namespace 55, which identifies the file system object and the updated GID 133 for the file system object. The update to the GID 133 can, for example, be iterated. By way of example, the semaphore component 122 can be prompted to iterate the GID 133 of a given file system object after a designated or known set of file system operations are performed on that file system object. As an alternative, the semaphore component 122 can use alternative modification logic to modify a user identifier (UID), permission settings, file size, or mtime. In this way, the validation of the state of individual file system objects to reflect performance of mutable operations at the filer 30 can be determined from the comparison iterated/modified metadata item (e.g., GID). Once modified, the updated GID 133 can be stored in the virtual namespace 55.

According to an aspect, the client system 100 is able to specify a mutable operation on a particular file system object, and responsive to issuing the file system operation, verify that the file system object is the same at both the filer 30 and the destination filer 40. In other words, the client system 100 can verify that the mutable operation specified on the file system object at the filer 30 is carried through to the destination filer 40, so that the file system object is the same at both the source and destination filers 30, 40. In implementation, the file system client 110 can identify a file system object, query the filer 30 for its metadata, and specify a mutable file system operation for that object. The semaphore component 122 of the verification component 120 can specify an operation to write a particular metadata item (e.g., GID) of the specified file system object. By way of example, the semaphore component 122 can iterate or otherwise increment the GID of the specified file system object. The semaphore component 122 can store the update to the particular file system objects metadata item (e.g., using a local store). The verification component 120 can query through the file system client 110 the destination filer 40 for the metadata of the file system object, and then compare the semaphore from the metadata of the file system object at the destination filer 40 with a most recent semaphore value stored for that file system object. If the comparison yields a matching semaphore value, then the verification component 120 determines that the file system object is quiesced at the destination filer 40. Once quiesced, the verification component 120 can validate the migration and the implementation of the mutable file system operation for the file system object at the destination filer 40.

Additionally, the verification component 120 can compare the file system object that is deemed quiesced to the corresponding file system object of the control data set 50 to ensure that no data corruption occurred during the migration. At that point, check operations 129 can be issued by the file system client 110 against the active migration dataset, and specifically between the control data set 50 and destination file system 40. The check operations 129 can be issued with control 139 signaled to or otherwise established with the file system client 110 to preclude the file system client 110 from issuing additional file system operations that specify the corresponding file system object on the filer 30 until the check operation(s) has fully completed. Once the check is complete, the control 139 can enable further operations. s

The result of the check operation 129 can be stored as a verification record 143 in a verification store 145. In one implementation, the individual records 143 can include the identifier of the file system object, one or more file system operations 111 performed on the source for the corresponding object (e.g., the most recent operation performed), and the result of the check operations 129. As an addition or variation, the records 143 can also include the time when the file system operation was performed on the filer 30 and/or migrated to the destination filer 40. The result of the check operations 129 can correspond to, for example, a value that identifies whether the file system object on the destination filer 40 is corrupted based on the data of the control data set 50. The value can indicate corruption of either the file system object or its metadata.

Accordingly, the verification component 120 operates to detect in near real-time when file system objects of the data stores being validated are corrupted. When the appliance is the migration appliance 21, the integrity detection is performed for the appliance, for the file system 30 and/or for the destination file system 40. In one implementation, the verification component 120 performs check operations between the filer 30 and the control data set 50 to detect presence of corrupted file system objects in the filer 30.

Cache Appliance

The client system 100 can also operate to validate the performance of the cache appliance 31 in implementation system 10B. In an example of FIG. 1B, cache appliance 31 operates to (i) intercept file system operations issued from the client system 100, and forward file system operations 111 to the file system 30, and (ii) intercept responses to the file system operations form the file system 30, and forward the responses to the client system 100. The cache appliance 31 can intercept file system operations to enhance performance and speed for the client system, while providing data protection of the data being migrated. An example of a cache system is provided with U.S. patent application Ser. Nos. 14/031,018, 14/031,019, 14/031,023, and 14/031,026; all of which are hereby incorporated by reference in their respective entirety.

In more detail, one implementation provides for the cache appliance 31 to include the source interface 72, data replication engine 74, operation replication engine 76, and cached data set 78. The data replication engine 74 can retrieve data sets 75 from the filer 30 in order to populate the cached data store 78 with a data set from the filer 30. The caching can be performed while the filer 30 is in active use by the client system 100. The source interface 72 can intercept the file system operations 111 issued by the client system 100 and intended for the filer 30. Additionally, the source interface 72 can forward intercepted file system operations 111 onto the filer 30. The operation replication engine 76 can replicate operations on the cached data store 78 in order to maintain coherency between the cached data and the filer 30. In this way, the cached data 78 maintains coherency with the filer 30.

The client system 100 operates to generate loads on the cache appliance 31 in order to detect corruption errors in the data sets of the file system 30 and/or cache data set 78. This process can be performed while the cache appliance 31 is in active use on the implementation system 10B. The corruption errors that can be detected include both temporary and permanent corruption of file system objects. More specifically, the client system 100 can perform comparisons between the control data set 50 and data of the cache appliance 31, as well as between the control data set 50 and data of the filer 30.

Accordingly, the verification component 120 operates to detect in near real-time when file system objects of the cache data store 78 are being corrupted. When the appliance is the cache appliance 31, the integrity detection is performed for the cache data store 78 of the appliance 31 and/or for the file system 30. In one implementation, the verification component 120 initiates check operations 129 through the file system client 110 for each of the filer 30, cache appliance 31, and the control data set 50. The verification component 120 analyzes the results 149 of the check operations to detect discrepancies as between the control data set 50 and the filer 30, as well as between the cache data 78 and the control data set 50.

Filer Under Test

While examples of FIG. 1A and FIG. 1B illustrate a test environment in which a network file system includes a fronted appliance under test, FIG. 1C illustrates a variation in which the system 100 is implemented with just the filer 30 under test. For example, the client system 100 can be used to generate a load for filer 30, representing the file system under test. In such an implementation, appliance 21, 31 (see FIG. 1A and FIG. 1B respectively) and/or destination filer 40 (see FIG. 1A) may not exist. Rather the control data set 50 represents file system objects copied from the filer 30. In the implementation system 10C, the client system 100 can issue file system operations directly to the filer 30. As described with other examples, the file system operations can be mirrored onto the control data set 50.

During a test session, verification component 120 of client system 100 can compare the control data set 50 to the file system objects of the filer 30 on an ongoing basis, in order to determine discrepancies between the control data set 50 and the filer 30. In one implementation, the verification component 120 can issue through the client file system 110 check operations 129 on the file system 30 in order to determine results 149. A comparable set of check operations 129 can be issued for the control data set 50, and the results can be compared. As described with other examples, the discrepancies can include those caused by temporary corruption issues, which under conventional approaches have been difficult to spot.

Analysis Component

With any of the examples of FIG. 10A through FIG. 10C, analysis component 148 represents a process that can scan, aggregate, and/or analyze the verification records 143 in order to generate output about the resource being tested or used in the test environment. The analysis component 148 can identify, for example, the number of instances in which data corruption occurred, when in the session the corruption occurred, and file system operations of client system 100 which may have caused or triggered the corruption. The output of the analysis component 148 can be used to determine, for example, the reliability of the file system resource being tested. The determination made can include determining conditions or triggers which may cause corruption (e.g., specific file system operations or data sets that can make corruption more likely). In this manner, the metrics can thus determine an integrity level of the data migration appliance 21, cache appliance 31, or filer 30, based on the selected testing environment.

Methodology

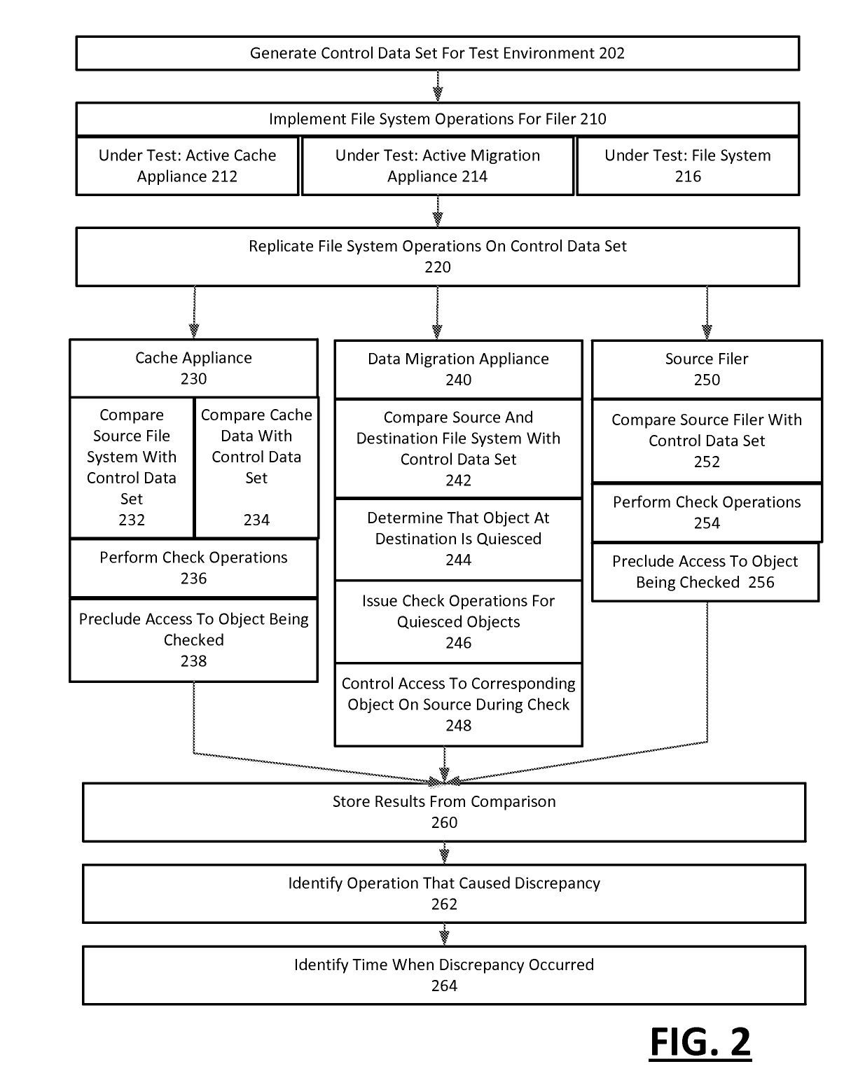

FIG. 2 illustrates an example method for evaluating resources of a network file system in a test environment, according to an embodiment. A method such as described with FIG. 2 can be implemented using a client system, such as described with an example of FIG. 1A through FIG. 1C, and further within a test environment, such as described with the implementation systems 10A, 10B, and 10C of FIG. 1A through FIG. 1C. Accordingly, in describing an example of FIG. 2, reference may be made to elements of FIG. 1A through FIG. 1C for the purpose of illustrating a suitable component for performing a step or sub-step being described.

With reference to FIG. 2, a test environment is established for evaluating a particular resource of a network file system (202). As described with other examples, a resource under test can correspond to an appliance of the network file system, such as a cache or data migration appliance that fronts the network file system. In variations, the resource under test can correspond to a filer, in and of itself, without use of an appliance. The test environment can include client system 100 to issue file system operations. In some embodiments, the test environment includes an appliance (e.g., the cache or migration appliance being tested), a file system and a control data set. The appliance can correspond to, for example, a cache appliance or a data migration appliance. The file system's data set can be based on an actual file system that is to be provided in active use with the file system and/or appliance 21. The control data set 50 can be a direct copy of the file system's data set. For example, in the context of migration, the control data set 50 can be a copy of a portion of a source file system that is to undergo migration in the active operational environment. Likewise, the control data set 50 can correspond to the source filer when the appliance being tested is a cache appliance. In examples when no appliances is used, but rather the resource under test is the filer itself, the control data set can replicate the filer. In this way, the control data set 50 can be specific to the operation environment of the host, rather than generic data that is independent of the host system. The implementation can mount the client system 100 to the file system data set. Depending on the implementation, the appliance 21, 31 (e.g., cache or migration appliance) is positioned in line to intercept communications exchanged between the file system and the file system data set.

When a session for the test environment is initiated, the client system 100 generates file system operations for the file system data set (210). In some implementations, the test environment evaluates a resource of the network file system corresponding to a cache appliance, which access and stores portions of the file system data set in cache memory (212). In variations, the test environment evaluates a resource of the network file system corresponding to a migration appliance, which migrates the file system data set from a filer 30 to a destination filer 40. (214). Still further, in some variations, the test environment can be used to evaluate the network file system (216).

In implementations in which the resource under test is an appliance, the appliance may front the network file system, so that the appliance intercepts the file system operations and forwards the file system operations to the file system. Additionally, the fronting appliance 21, 31 can intercept responses from the file system and forward the responses to the client system 100. In this way, the client system 100 can issue file system operations for the file system, which can be selectively intercepted by the appliance 21, 31. The appliance 21, 31 can implement the intercepted file system operations on the stored file system data and then provide the response to the client system 100. At the same time, the appliance 21, 31 can mirror operations to the file system in order to preserve coherency with the file system data set. When the appliance 21 is a migration appliance, the client system 100 issues file system operations on the source file system which may be mirrored on a destination filer 40.

In one implementation, the client system 100 determines a namespace 55 for the file system data set. The namespace can be used to select and structure the file system operations that are issued from the client system 100.

As described with the examples of FIG. 1A through FIG. 1C, the file system operations issued from the client system 100 are also replicated on the control data set 50 (220). In one implementation, the client system 100 includes the file system client 110 to select and structure file system operations. The selection and structuring of the file system operations can be to simulate the active load of the file system. The file system client 110 can include or be implemented with the mirroring component 112 to generate the mirroring file system operations on the control data set 50.

When the resource under test corresponds to the active cache appliance (230), then the comparisons performed can include one or both of (i) the file system data set as compared to the control data set 50 (232), and (ii) the cached data set as compared to the control data set 50 (234). Check operations can be issued for data from either the file system data set or the cached data set (236). The comparison can be performed in real-time, for example, when the file system under test is in use, and/or when the appliance 31 is caching while handling file system operations. In order to perform the comparison, the client system 100 can issue the check operations for the file system 30 and/or cache data set 78, and the results 149 of the check operation 129 can be communicated to the verification component 120. The verification component 120 can compare the results 149 (including data and metadata) of the check operations in order to determine discrepancies as between the file system objects and corresponding objects of the control data set 50. The client system 100 can preclude access to the file system object(s) being checked until the comparison is determined (238).

When implemented as a migration system (240), the data set of either the source or destination filers 30, 40 can be compared to the control data set 50 (242). The comparisons can be made in real-time, as the migration is being performed. When the file system objects of the destination filer 40 are compared, a determination can be made as to whether a selected file system object is quiesced (244). The check operations 129 can be issued for those destination file system objects that are deemed quiesced (246). While the check operation is ongoing, the corresponding file system object of the filer 30 can be flagged or otherwise controlled so that the client system 100 is precluded from specifying file system operations for that source object (248).

When implemented for a file system under test (250), the data set of the filer can be compared to the control data set 50 (252). As with other examples, the comparison can be made in real-time. The check operations can be issued to retrieve results of the filer 30 and control data set 50, which in turn are compared to identify discrepancies (254). Also, while the check operation is ongoing, the corresponding file system object of the filer 30 can be flagged or otherwise controlled so that the client system 100 is precluded from specifying file system operations for that source object (256).

Results from the comparison can be stored (260). In one implementation, records 143 can be stored that indicate the results of the comparisons as between the file system objects and the control data. The results can, for example, reflect Boolean values such as “pass” or “fail” which reflect whether the file system object that is evaluated matches the corresponding data of the control data set 50. The overall analysis can identify a performance level of the appliance 21, 31, or filer under test 30, which may be based on, for example, a ratio or count of instances when discrepancies occurred with use of the appliance 21, 31, or filer under test 30. The records 143 can also track the file system operations that were performed on the respective file system objects, particularly before the discrepancy occurred (262). Such information can identify operations or conditions that increase the likelihood of corruption. As an addition or alternative, the records 143 can include timestamps that reflect when discrepancies occurred (264). Such information can also be useful in determining causes or conditions resulting in an increase of likelihood that corruption will occur.

Computer System

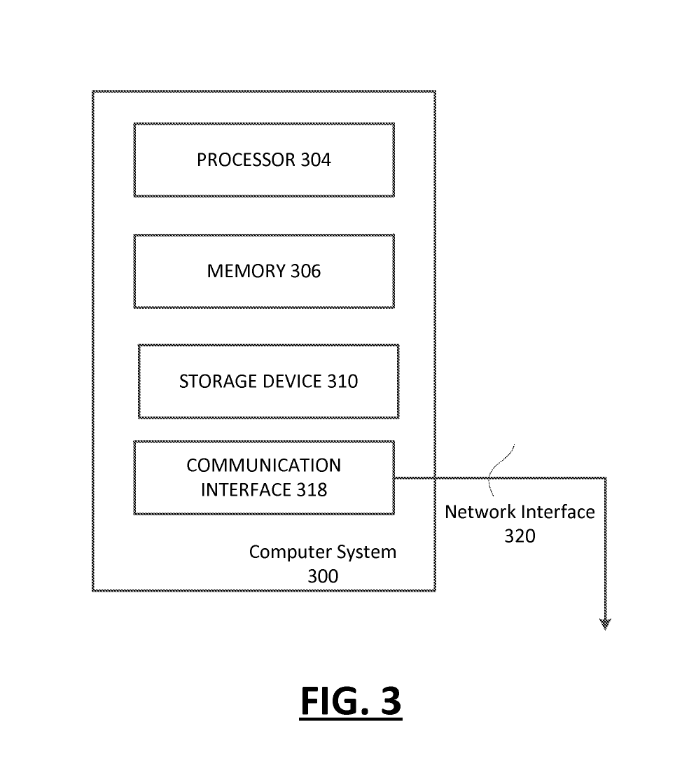

FIG. 3 is a block diagram that illustrates a computer system upon which embodiments described herein may be implemented. For example, in the context of FIG. 1A through FIG. 1C, client system 100 can be implemented using one or more computer systems such as described by FIG. 3. Still further, methods such as described with FIG. 2 can be implemented using a computer such as described with an example of FIG. 3.

In an embodiment, computer system 300 includes processor 304, memory 306 (including non-transitory memory), storage device 310, and communication interface 318. Computer system 300 includes at least one processor 304 for processing information. Computer system 300 also includes a memory 306, such as a random access memory (RAM) or other dynamic storage device, for storing information and instructions to be executed by processor 304. The memory 306 also may be used for storing temporary variables or other intermediate information during execution of instructions to be executed by processor 304. Computer system 300 may also include a read only memory (ROM) or other static storage device for storing static information and instructions for processor 304. A storage device 310, such as a magnetic disk or optical disk, is provided for storing information and instructions. The communication interface 318 may enable the computer system 300 to communicate with one or more networks through use of the network link 320 (wireless or wireline).

In one implementation, memory 306 may store instructions for implementing functionality such as described with the client system 100 of FIG. 1A through FIG. 1C, or implemented through an example method such as described with FIG. 2. Likewise, the processor 304 may execute the instructions in providing functionality as described with the client system of FIG. 1A through FIG. 1C, or performing operations as described with an example method of FIG. 2.

Embodiments described herein are related to the use of computer system 300 for implementing the techniques described herein. According to one embodiment, those techniques are performed by computer system 300 in response to processor 304 executing one or more sequences of one or more instructions contained in the memory 306. Such instructions may be read into memory 306 from another machine-readable medium, such as storage device 310. Execution of the sequences of instructions contained in memory 306 causes processor 304 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A non-transitory computer-readable medium that stores instructions that, when executed by one or more processors of a computer system, cause the computer system to perform operations that comprise:
(a) establishing a client system to utilize a test environment, the test environment including a plurality of resources, including a file system comprising a plurality of file system objects, the test environment implementing one or more resources that are to be under test in a test session;
(b) creating a control data set that is based on the plurality of file system objects of the file system;
(c) initiating a test session in which the client system issues a plurality of file system operations, wherein at least some of the plurality of file system operations are each a mutable operation that specifies a corresponding file system object of the file system, the plurality of file system operations being issued to create, modify or delete file system objects that are stored with one or more data stores associated with the resource under test, the file system objects that are stored with the one or more data stores having corresponding data with the control data set;
(d) while the client system issues the plurality of file system operations, replicating the plurality of file system operations on the control data set; and
(e) determining whether a discrepancy exists between individual file system objects that are stored with the one or more data stores and corresponding data of the control data set.

2. The non-transitory computer-readable medium of claim 1, wherein (a) includes establishing the client system to utilize a file system that is fronted by a cache appliance, wherein the resource under test is the cache appliance, and wherein the one or more data stores associated with the resource under test include a data store of the cache appliance and the file system.

3. The non-transitory computer-readable medium of claim 1, wherein (a) includes establishing the client system to utilize a file system that is fronted by a data migration appliance, wherein the resource under test is the migration appliance, and wherein the one or more data stores associated with the resource under test include the file system and a destination file system that is a target of the migration.

4. The non-transitory computer-readable medium of claim 1, wherein (a) includes establishing the client system to utilize the file system as the resource under test, and wherein the one or more data stores associated with the resource under test include the file system.

5. The non-transitory computer-readable medium of claim 1, wherein (b) includes generating a copy of the file system as the control data set.

6. The non-transitory computer-readable medium of claim 2, wherein (e) includes determining the discrepancy between mutated file system objects of at least one of (i) the file system or (ii) the cache data store, to the corresponding data of the control data set.

7. The non-transitory computer-readable medium of claim 3, wherein (e) includes determining the discrepancy between file system objects that are migrated from the file system onto a destination and corresponding data of the control data set.

8. The non-transitory computer-readable medium of claim 7, wherein (e) includes (i) determining when file system objects migrated to the destination are quiesced while the appliance migrates file system objects from the file system to the destination, and then (ii) comparing individual file system objects at the destination which are determined to be quiesced to corresponding data of the control data set.

9. The non-transitory computer-readable medium of claim 8, further comprising instructions that, when executed by the one or more processors of the computer system, cause the computer system to control the client system from performing an operation that specifies a file system object of the file system that corresponds to an individual file system object at the destination which is being compared to the corresponding data of the control data set, until comparing is complete.

10. The non-transitory computer-readable medium of claim 1, further comprising instructions that, when executed by the one or more processors of the computer system, cause the computer system to control the client system from performing an operation that specifies a file system object of the file system that is being compared to the corresponding data of the control data set.

11. The non-transitory computer-readable medium of claim 1, wherein (e) includes comparing a file system object of the set of file system objects to corresponding data of the control data set.

12. The non-transitory computer-readable medium of claim 11, wherein comparing the file system object includes performing one or more check operations.

13. The non-transitory computer-readable medium of claim 11, further comprising instructions that, when executed by the one or more processors of the computer system, cause the computer system to generate and store a record that identifies a result of comparing a file system object of the set and the corresponding data of the control data set.

14. The non-transitory computer-readable medium of claim 1, further comprising instructions that, when executed by the one or more processors of the computer system, cause the computer system to determine a specific file system operation of the plurality of mutable file system operations from which the discrepancy immediately followed.

15. The non-transitory computer-readable medium of claim 1, further comprising instructions that, when executed by the one or more processors of the computer system, cause the computer system to determine a specific instance or interval of time when the session is ongoing during which the discrepancy occurred.

16. The non-transitory computer-readable medium of claim 1, wherein the computer system is implemented is implemented as part of a test environment.

17. A method for validating a file system under active use, the method being implemented by one or more processors and comprising:
(a) establishing a client system to utilize a test environment, the test environment including a plurality of resources, including a file system comprising a plurality of file system objects, the test environment implementing one or more resources that are to be under test in a test session;
(b) creating a control data set that is based on the plurality of file system objects of the file system;
(c) initiating a test session in which the client system issues a plurality of file system operations, wherein at least some of the plurality of file system operations are each a mutable operation that specifies a corresponding file system object of the file system, the plurality of file system operations being issued to create, modify or delete file system objects that are stored with one or more data stores associated with the resource under test, the file system objects that are stored with the one or more data stores having corresponding data with the control data set;
(d) while the client system issues the plurality of file system operations, replicating the plurality of file system operations on the control data set; and
(e) determining whether a discrepancy exists as between individual file system objects that are stored with the one or more data stores and corresponding data of the control data set.

18. The method of claim 17, wherein (a) includes establishing the client system to utilize a file system that is fronted by a cache appliance or a data migration appliance.

19. The method of claim 18, wherein (b) includes generating a copy of the file system as the control data set.

20. A computer system comprising:
one or more processors;
a memory that stores a set of instructions;
wherein the one or more processors use instructions stored in memory to:
(a) establish a client system to utilize a file system comprising a plurality of file system objects, in which an intermediate and in-line appliance is provided to intercept and forward communications directed for the file system;
(b) create a control data set that is based on the plurality of file system objects of the file system;
(c) initiate a session in which the client system issues a plurality of file system operations, each of the plurality of file system operations being a mutable operation that specifies a corresponding file system object of the file system, wherein the session is performed while the appliance operates to create, modify or delete a set of file system objects that are based on the file system and which are specified by the individual file system operations issued from the client system;
(d) while the client system issues the plurality of file system operations, replicate the plurality of file system operations on the control data set; and
(e) determine whether a discrepancy exists as between individual file system objects in the set of file system objects and corresponding data of the control data set.
